(19) United States
(12) Patent Application Publication
(10) Pub. No.: US 2024/0296181 A1
(43) Pub. Date: Sep. 5, 2024

(54) COMPILING ONTOLOGIES

(71) Applicant: Accenture Global Solutions Limited, Dublin (IE)

(72) Inventors: Nimrod Busany, Tel Aviv (IL); Gil Rosenblum, Tel Aviv (IL); Dan Klein, Rosh Ha'ayin (IL); Eitan Hadar, Nesher 02 (IL); Remya Ramachandran, Bangalore (IN)

(21) Appl. No.: 18/176,970

(22) Filed: Mar. 1, 2023

(51) Int. Cl. G06F 16/36; G06F 40/279

(52) U.S. Cl. CPC G06F 16/367; G06F 40/279

(57) ABSTRACT

Implementations include methods, systems, computer-readable storage medium for compiling ontologies. A method for providing a composite ontology from a plurality of base ontologies, each ontology being provided as a computer-readable data structure, includes: identifying a plurality of base ontologies; and combining the plurality of base ontologies to generate a composite ontology by, automatically: comparing entity names of classes of a first base ontology to classes of a second base ontology, and determining that an entity name of a first class of the first base ontology matches an entity name of a second class of the second base ontology, and in response, providing a class within the composite ontology that represents the first class and the second class at least partially by determining a union of data properties, object properties, and cardinality restrictions of the first class and the second class for the class.

### FIELD

This specification relates to systems for compiling ontologies.

### BACKGROUND

Conceptual data models such as formal Ontology Language (OWL) ontologies are machine interpretable models with rich semantics. Hence, ontologies can be useful for data organization and reasoning, and can be used to mitigate data management challenges.

### SUMMARY

Implementations of the present disclosure are directed to systems and methods for automatically merging ontologies, analyzing, identifying, and reporting inconsistencies, resolving duplication, performing ontology differencing to ensure model synchronization, and implementing mechanisms that enable selective ontology merging. Multiple ontologies can be merged together by identifying common entity names of classes (also referred to as types). An ontology compiler can be used to automatically create composite ontologies by merging multiple ontologies. The ontology compiler can update the composite ontology as and when the merged ontologies change.

In some implementations, actions include providing a composite ontology from a plurality of base ontologies, each ontology being provided as a computer-readable data structure, including: identifying a plurality of base ontologies; and combining the plurality of base ontologies to generate a composite ontology by, automatically: comparing entity names of classes of a first base ontology to classes of a second base ontology, and determining that an entity name of a first class of the first base ontology matches an entity name of a second class of the second base ontology, and in response, providing a class within the composite ontology that represents the first class and the second class at least partially by determining a union of data properties, object properties, and cardinality restrictions of the first class and the second class for the class.

Other implementations of this aspect include corresponding systems, apparatus, and computer programs, configured to perform the actions of the methods, encoded on computer storage devices.

These and other implementations can each optionally include one or more of the following features: a base ontology of the plurality of base ontologies includes one or more entities including at least one of classes, sub-classes, data properties, object properties, and cardinality restrictions; the method comprises: after combining the plurality of base ontologies to generate the composite ontology, identifying duplicate entities; and removing the identified duplicate entities from the composite ontology; combining the plurality of base ontologies to generate the composite ontology comprises: combining a first portion of the first base ontology with a second portion of the second base ontology, the first portion and the second portion being selected based on a set of merging policies; the set of merging policies specifies, for an entity of the first base ontology or the second base ontology, whether the entity is to be included in the composite ontology; the set of merging policies specifies, for a first entity of the first base ontology or the second base ontology, whether a second entity is to be included in the composite ontology, the second entity being linked to the first entity; the second entity is linked to the first entity by one or more of: the second entity is a parent or child of the first entity; the second entity is a property of the first entity; the second entity is an inherited property of the first entity; the second entity is a referenced class of the first entity; and the second entity is a sub-class of the first entity; the set of merging policies specifies properties of entities that are to be included in the composite ontology; the method includes receiving, as user input, policy data defining the set of merging policies; the method includes detecting a change to at least one of the plurality of base ontologies; and updating the composite ontology based on the detected change to the at least one of the plurality of base ontologies; updating the composite ontology based on the detected change to the at least one of the plurality of base ontologies comprises applying one or more update rules to the composite ontology; the one or more update rules are received as user input; updating the composite ontology based on the detected change to the at least one of the plurality of base ontologies comprises: removing, from the composite ontology, an entity that was removed from a base ontology of the plurality of base ontologies; updating the composite ontology based on the detected change to the at least one of the plurality of base ontologies comprises: adding, to the composite ontology, an entity that was added to a base ontology of the plurality of base ontologies; detecting a change to at least one of the plurality of base ontologies comprises detecting a change input by a user to the at least one of the plurality of base ontologies; a base ontology of the plurality of base ontologies represents a set of programmatic specifications; a base ontology of the plurality of base ontologies represents databases of tables; the method comprises presenting a visual representation of the composite ontology on a user interface.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF THE DRAWINGS

FIG. 1 depicts an example architecture that can be used to execute implementations of the present disclosure.

FIG. 2 depicts an example system for generating ontologies in accordance with implementations of the present disclosure.

FIG. 3 depicts an example system for compiling ontologies in accordance with implementations of the present disclosure.

FIGS. 4A and 4B show an example user interface in accordance with implementations of the present disclosure.

FIG. 5 is a flowchart of an example process that can be executed in accordance with implementations of the present disclosure.

Like reference numbers and designations in the various drawings indicate like elements.

### DETAILED DESCRIPTION

Implementations of the present disclosure are directed to systems and methods for automatically merging ontologies, analyzing, identifying, and reporting inconsistencies, resolving duplication, performing ontology differencing to ensure model synchronization, and implementing mechanisms that enable selective ontology merging. Multiple ontologies can be merged together by identifying common entity names of classes (also referred to as types). An ontology compiler can be used to automatically create composite ontologies by merging multiple ontologies. The ontology compiler can update the composite ontology as and when the merged ontologies change.

Ontologies are a formal way to describe taxonomies and classification networks, defining the structure of knowledge for various domains. In some examples, nouns represent classes of objects and the verbs representing relations between the objects. While there exist many languages for describing a data model, a standard is Web Ontology Language (OWL). OWL is a family of knowledge representation languages for authoring ontologies. Ontology is a way of representing the knowledge on the semantic web. Usage of ontologies can be beneficial and efficient in various applications such as information retrieval, information extraction, and question answering.

Elements or entities of an ontology include Classes (also referred to as Types), Data Properties, Object Properties, Property Type Restrictions, and Property Cardinality Restrictions. Classes represent concepts in a domain. Data Properties are characteristics of Classes. Object Properties represent relations between Classes. Property Type Restrictions and Property Cardinality Restrictions specify constraints about the type and distinct values that a property can have for a given Class. For example, a Property Type Restriction can restrict a particular Property Type to being a number or a string. A Property Cardinality Restriction can restrict a number of a particular Property that can be assigned to a Class.

In general, an ontology is provided as a computer-readable data structure, such as a data graph, that consumes computing resources, such as processors and memory. A larger ontology requires more memory in order to store the ontology, and requires more processing power to use the ontology, as compared to a smaller ontology.

A composite ontology is a combination of multiple base ontologies. The term base ontology to can be used to refer to an ontology that is merged with at least one other base ontology to form a composite ontology. The term composite ontology can be used to refer to an ontology that results from the merging of multiple base ontologies. Each base ontology includes Classes, with each Class representing a concept. Each Class has Data Properties, Object Properties, and Cardinality Restrictions. Each Class, as an entity within an ontology, is assigned an Internationalized Resource Identifier (IRI) or universally unique identifier (UUID), and has a non-unique name.

In a traditional approach, multiple ontologies can be merged based on the IRI/UUID. Since no Classes have the same IRI/UUID, multiple Classes representing the same concepts will be included in the combined ontology. This results in duplicates, resulting in a larger data structure, requiring more memory for storage, because redundant data is recorded in the composite ontology.

In some cases, merging base ontologies and removing duplicates from a composite ontology is performed manually by a user. Manual removal of duplicates is time-consuming and consumes computing resources. Additionally, duplicates can occur any time one of the merged based ontologies changes, resulting in the deduplication process being repeated. Repeating this process as the base ontologies change is time intensive and error prone. Thus, relying on manual merging and updating will result in the composite model eventually becoming out-of-sync with the base ontologies.

In view of the above context, implementations of the present disclosure are directed to automatically merging base ontologies by comparing entity names and names that match are considered the same concept, so that only one Class for that concept is automatically included in the combined ontology. Further, the Data Properties, Object Properties, and Cardinality Restrictions of that one Class are determined by a union over the same for the multiple entities from the base ontologies. The merging and deduplication are performed automatically, without human intervention.

Base ontologies, or domain ontologies, may have many (e.g., thousands of) entities, and simply merging the ontology of multiple domains may yield a model that is significantly larger than the ontology required to model a specific cross-domain use-case. This results in the use of additional memory and processing power. An oversized composite model is also difficult to navigate, significantly slows down automatic reasoning, and makes model synchronization more challenging. Thus, the disclosed techniques employ automated selective merging using systematic and automatic decision-making about the selected entities. The disclosed techniques can thus be used to automatically, selectively merge fragments of domain ontologies that are relevant to the use-case of interest, resulting in smaller, targeted composite ontologies that consume less memory and less processing power.

Ontologies are fluid representations and can require updates over time to account for new information or structural needs. Updating an ontology can involve concept renaming, hierarchical changes, new or deleted concepts, and relationship changes. Base ontology models can evolve over time, making the composite ontology out-of-sync with the domain ontologies as the underlying base ontologies change.

The disclosed implementations can be used to incorporate the ontology compiler as part of a continuous integration and continuous delivery (CI/CD) pipeline to automatically identify when the composite model is out-of-sync and update the composite ontology accordingly. The disclosed implementations can boost sharing and reusing ontologies by creating a CI/CD process that is specifically meant for ontologies and ensures safe model updates. The updates can be automatically managed in a manner that reduces the risk of breaking existing infrastructure and processes in projects that rely on that ontology.

The ontology compiler can be integrated into an ontology-driven intelligent management system where data is a product. Data models (ontologies) that govern the different data products in an organization are managed. As new ontologies are introduced for specific data products, the ontology compiler can be run in order to create composite ontologies and update the composite ontologies as and when base ontologies change.

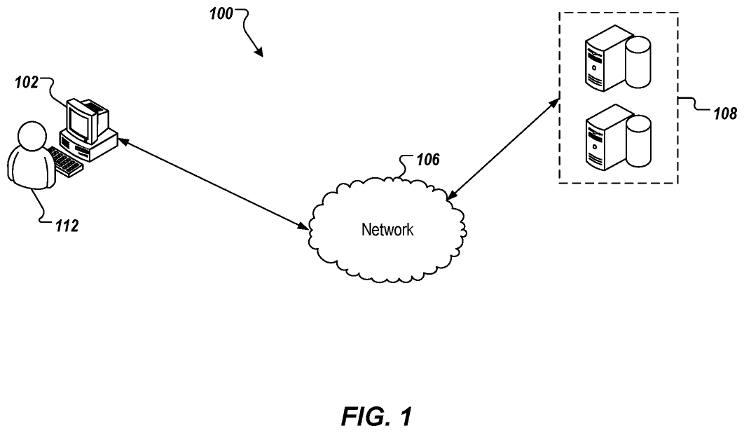

FIG. 1 depicts an example architecture 100 in accordance with implementations of the present disclosure. In the depicted example, the example architecture 100 includes a client device 102, a network 106, and a server system 108. The server system 108 includes one or more server devices and databases (e.g., processors, memory). In the depicted example, a user 112 interacts with the client device 102.

In some examples, the client device 102 can communicate with the server system 108 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 108 includes at least one server and at least one data store. In the example of FIG. 1, the server system 108 is intended to represent various forms of servers including, but not limited to a web server, an application server, a proxy server, a network server, and/or a server pool. In general, server systems accept requests for application services and provide such services to any number of client devices (e.g., the client device 102 over the network 106). In accordance with implementations of the present disclosure, and as noted above, the server system 108 can host a client development tool (CDT) platform.

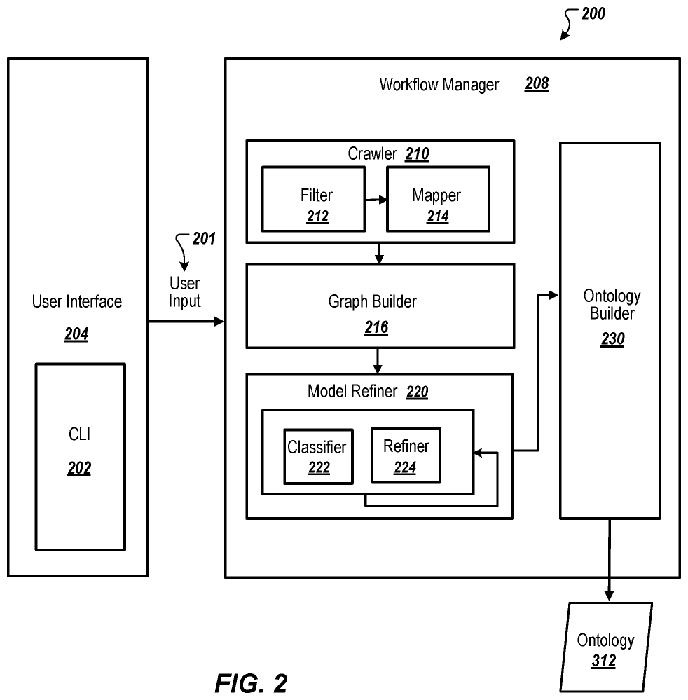

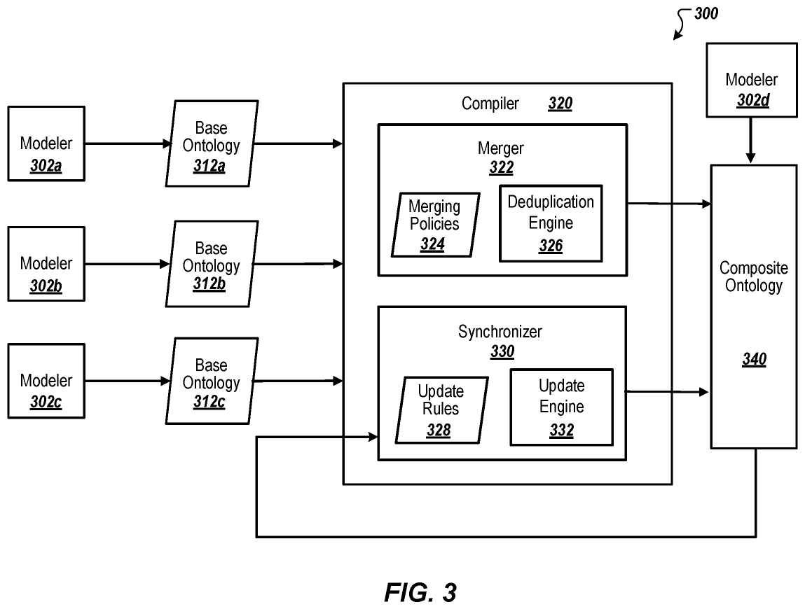

FIG. 2 depicts an example system 200 for generating ontologies in accordance with implementations of the present disclosure. The system includes a user interface (UI) 204 and a command line interface (CLI) 202. A CLI is a UI that is text-based. A CLI can be used to manage and view files. The system 200 includes a workflow manager 208. The workflow manager 208 manages a crawler 210, a graph builder 216, a model refiner 220, and an ontology builder 230. Operations of the workflow manager 208 are described in greater detail with reference to FIG. 3. The crawler 210 includes a filter 212 and a mapper 214. The model refiner 220 includes a set of classifiers 222 and a set of refiners 224.

In general, the crawler 210 scans a repository of programmatic specifications and loads and extracts object definitions from each specification. The graph builder 216 builds a knowledge graph representation of the objects. In some examples, the graph builder 216 is a types graph builder. The model refiner 220 applies a series of classification procedures to distinguish between conceptual objects that stand on their own to auxiliary objects, such as lists or Properties of other objects. Then, the model refiner 220 applies refinement procedures to produce a finer representation. The ontology builder 230 builds a single ontology 312a that captures all conceptual objects that the specifications expose, their properties, their relations to other objects, and axioms that described them. The model is also enriched with textual descriptions for all the above taken from the specifications.

The crawler 210 crawls over the documents in the input path and pulls data from the documents. The crawler 210 includes a filter 212 that filters out irrelevant information from the collected data as determined by the configuration of the crawler 210. The configuration defines the crawling method performed by the crawler 210. For example, if a service includes multiple versions of a specification, the crawler 210 can be configured to take the most recent version. The criteria can also indicate which specifications are out-of-the-scope for the analysis. The crawler 210 can recursively search the repository and extract files that fit the crawling criteria.

The crawler 210 includes a mapper 214 that maps definitions in the specifications to their ontological corresponding concepts. The concepts can include, for example, class, property, link, etc. After the files are collected, the crawler 210 parses each file and extracts definitions of the supported ontological information, such as object types and their properties. The crawler 210 creates a standard representation of the extracted types. Each type is given a unique resource identifier (URI). References to a type are made by its URI. Each type can be encoded as a dictionary that includes its description, and its properties. The properties are encoded as a dictionary that maps property names to their type. The property type can be primitive, references to other objects, or arrays of the single types (primitive or objects). Properties that hold arrays can be enriched with cardinality constraints that describe the minimal or maximal number of values that they can hold. In addition, inheritance relations and links within the specification can be encoded in the deriving type using the URI of the parent type(s).

Once all specifications are scanned, the graph builder 216 encodes the extracted types as an initial graph (e.g., a type graph). The graph builder 216 forms the initial graph, which unifies the extracted types and stores their properties and relationships. In the initial graph, nodes can represent types, and edges can represent relations between the types.

The model refiner 220 takes the initial graph produced by the type graph builder 216 and runs a series of classification-refinement steps until a stable model is obtained. Each step includes a classification sub-step and a refinement sub-step. The model refiner 220 applies a series of classification and refinement procedures performed by the classifier 222 and the refiner 224 in order to refine the model reflected by the knowledge graph. In some examples, the model refiner 220 refines the graph based on user input 201. In some examples, the user input 201 can identify that a specific entity needs to be refined. In some examples, the user input 201 can indicate whether an entity is conceptual or not conceptual. In some examples, the set of classifiers 222 of the model refiner 220 identifies entities that are properties of other entities, and the set of refiners 224 collapses the entities to refine the graph. Thus, each classification is followed by a refinement procedure performed by the refiner 224. The model refiner 220 iterates all nodes in the graph, and refines the classified nodes by a pre-defined set of rules.

After the model refiner 220 applies all required classification-refinement operations, the ontology builder 230 builds an OWL ontology 312a. The ontology builder 230 outputs the ontology 312a describing the services and assets provided by the cloud provider. The output ontology 312a is in OWL format and describes the data collected. The ontology builder 230 generates the ontology 312a by expressing language constructs in OWL. In this way, the ontology builder 230 outputs the ontology 312a in a standard language.

OWL supports a formal definition of Classes, Properties, Relations, and Constraints. A relation between Classes can take the form of associations (e.g., property of) or hierarchies (e.g., polymorphism). The OWL ontology is an ontology language for the Semantic Web with formally defined meaning. The OWL ontology can express Classes, Data Properties, Object Properties, Individuals (Instances), Primitive Data Types, and axioms such as Sub-Classof, Property Cardinality Constraints, and Property Type Constraints.

FIG. 3 depicts an ontology compiling system 300 in accordance with implementations of the present disclosure. The system 300 includes a compiler 320 that generates a composite ontology 340 from base ontologies 312a, 312b, 312c.

Ontologies can define information about specific domains. When a use-case intersects multiple domains, various modular domain-specific ontologies can be merged. The ontology compiling system 300 performs functions such as merging base ontologies, checking for consistency between the merged ontologies, eliminating entities and associations duplications due to modular ontologies overlapping, identifying and selecting fragments that are relevant to the integration use-case, and keeping the composite model changes and mergers updated as the underlying merged base ontologies change.

The system 300 includes modelers 302a, 302b, 302c, and 302d (“modelers 302”). The modeler 302a models base ontology 312a, the modeler 302b models base ontology 312b, and the modeler 302c models base ontology 312c. The modeler 302d models composite ontology 340. The modelers 302 can each be a system 200 for generating and modifying ontologies, such as the system 200. In some examples, one or more of the modelers 302 can be a user. The modelers 302 can add and remove entities from the respective ontologies.

The compiler 320 includes a merger 322 and a synchronizer 330. The merger 322 applies merging policies 324 to merge the base ontologies 312a, 312b, 312c (“base ontologies 312”). Ontology merging refers to the process of creating a composite ontology (e.g., composite ontology 340) from two or more base ontologies 312. Merging two or more base ontologies can be defined as the union of their statements (e.g., definitions of Classes, Sub-Classes, Data Properties, Object Properties, Cardinality Restrictions). Thus, the composite ontology 340 includes the definitions that are defined in the base ontologies 312.

In some examples, the merger 322 employs merging policies 324 to selectively choose fragments of base ontologies 312 to include in the composite ontology 340. In this way, the merger 322 performs selective ontology merging in order to model a subset of the entities that are defined in the based ontologies 312. In some examples, the merging policies 324 include policies that are specific to a set of base ontologies 312. For example, a subset of the merging policies 324 can be assigned to the set of base ontologies 312 including base ontologies 312a, 312b, 312c. A different subset of the merging policies can be assigned to a different set of base ontologies that may be compiled by the compiler 320.

As domain ontologies can include thousands of conceptual definitions, the capability of selectively choosing portions of base ontologies is significant in order to reduce the size and complexity of the resulting composite ontology. To perform selective merging, the merger 322 uses the merging policies 324 to determine how to treat relations between selected concepts and non-selected concepts, in order to determine which entities (e.g., Classes) from the base ontologies 312 to include in the composite ontology 340, and which entities from the base ontologies 312 to omit from the composite ontology 340.

Choosing an entity from a base ontology to include in a composite ontology requires automated decision making about the entity. For example, if a Class has a property that references another Class that is not selected, then the merger 322 uses the merging policies 324 to determine whether the referenced Class should be included; whether properties should be removed; or whether the property should change to a Data Property (e.g., value based, instead of reference based). Similarly, if a Class is connected to another Class with an inheritance relation, and the parent Class was not selected, then the merger 322 uses the merging policies 324 to determine whether to include the parent Class (and its parents), whether to only include the inherited properties; or whether to emit both the parent or parents and their respective properties. Thus, the merger 322 chooses the fragments of the merged ontologies selectively and systematically based on the merging policies 324.

The merging policies 324 can include a set of policies that are defined at the ontology or entity level. In some examples, the merging policies 324 are received as user input. The merger 322 reads the merging policies 324 and applies the merging policies 324 automatically during the ontology merging process.

The set of merging policies 324 specifies, for a Class of a base ontology, whether the Class is to be included in the composite ontology. The set of merging policies 324 specifies, for a first Class in a base ontology, whether a second Class is to be included in the composite ontology, where the second Class is linked to the first Class. The second Class can be linked to the first Class, for example, by being a parent (e.g., Class) or child (e.g., Sub-Class) of the first Class. In some examples, the second Class can be linked to the first Class by being a property of the first Class. The second Class can be linked to the first Class by being an inherited property of the first Class. The second Class can be linked to the first Class by being a referenced class of the first Class.

The set of merging policies 324 can include different categories of policies. A first category of merging policies 324 can include policies related to inheritance. Example policies related to inheritance include: “Include Direct Parents,” “Include all Parents,” “Include Inherited Properties,” and “Ignore Inheritance.”

A second category of merging policies 324 can include policies related to object properties. Example policies related to object properties include: “Include Referenced Classes,” “Ignore Referenced Classes,” and “Convert Object Property to Data Properties.”

A third category of merging policies 324 can include policies related to sub-classes. Example policies related to sub-classes include: “Include Direct Sub-Classes,” “Include all Sub-Classes,” and “Ignore Sub-Classes.”

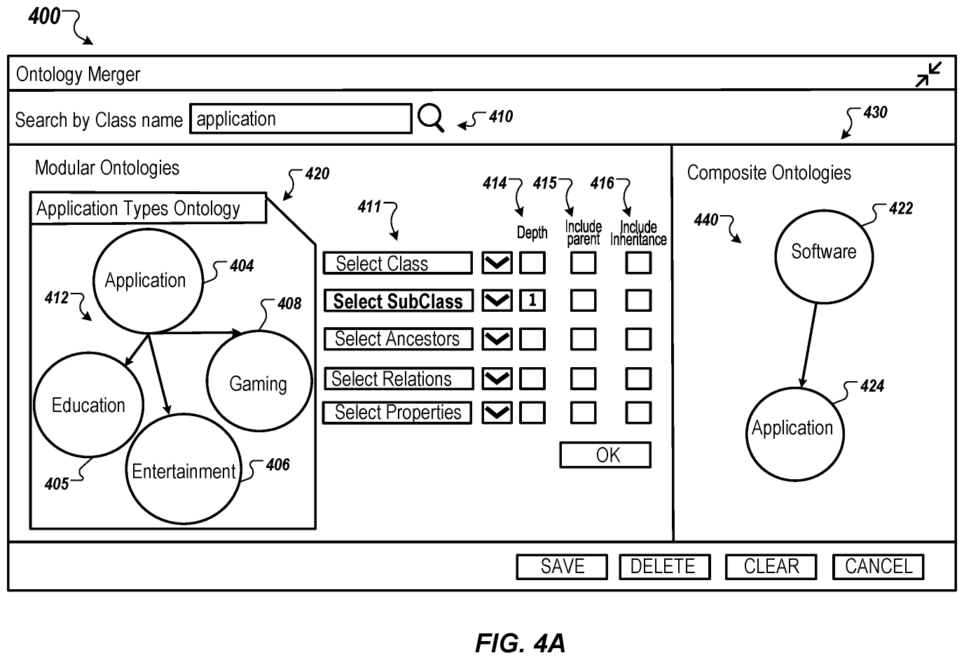

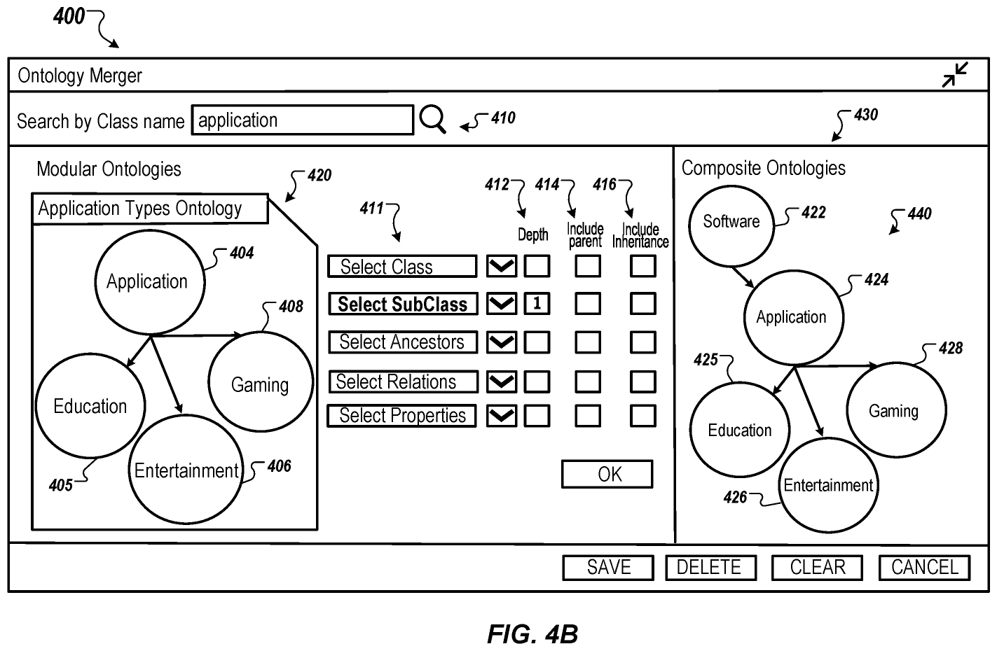

An example of merging ontologies using merging policies 324 is illustrated in FIGS. 4A and 4B, which show example user interfaces in accordance with implementations of the present disclosure. As shown in FIGS. 4A and 4B, a user can select and compose entities from multiple ontologies by searching and marking entities from a large repository of reusable ontologies. The selected entities are merged using the ontology merging feature described with reference to FIG. 3. Then, an ontology synchronization operation is performed to ensure model consistency between base ontologies and composite ontologies, as the modular base ontologies change.

FIG. 4A shows a user interface 400 for a Data Catalog tool that includes multiple ontologies and have a search capability. Using the user interface 400, a user searches and selects a Class to include in the composite ontology, and selects a selection policy, or merging policy, that takes all Sub-Classes up to a specific depth. The user interface 400 displays a diagram of a modular ontology, or base ontology 412, in window 420. The user interface 400 displays a diagram of a composite ontology 440 in window 430. The composite ontology 440 in the window 430 is a result of previous selections made for inclusion of classes in the composite ontology. The composite ontology 440 includes classes “Software” 422 and “Application” 424.

Referring to FIG. 4A, a user-input search query is received through a search bar 410. The search query specifies a Class name of “Application.” In response to receiving the search query, the system identifies ontologies from a catalog that satisfy the search query. The user interface 400 can then present, to the user, a list of ontologies that satisfy the search query (e.g., ontologies with Class “Application”). The system receives, through the user interface 400, a user selection of one of the provided ontologies. The selected ontology is then shown in window 420. In the ontology shown in window 420, the Class “Application” 404 has three Sub-Classes: “Education” 405, “Entertainment” 406, and “Gaming” 408.

User input is received through the user interface 400 specifying merging policies 324. The user interface provides options 411 for the merging policies 324, including “Select Class,” Select SubClass,” “Select Ancestors,” “Select Relations,” and “Select Properties.” The user interface 400 also provides selectable options for “Depth” 414, “Include Parent” 415, and “Include Inheritance” 416. In the example of FIG. 4A, the selection received from the user specifies a merging policy 324 of “Select SubClass: 1.” This indicates that subclasses up to a depth of one are to be included in the composite ontology 440.

Referring to FIG. 4B, upon receiving user input specifying the merging policies 324, the merger 322 automatically computes the set of selected Sub-Classes and adds the Sub-Classes to the composite ontology 440 in the window 430. The resulting composite ontology 440 includes Class “Application” 424 and Sub-Classes “Education” 425, “Entertainment” 426, and “Gaming” 428.

The Sub-Classes are added to the composite ontology 440 automatically based on the user-specified merging policies 324. This allows the compiler 320 to automatically include new sub-classes as the number of ontologies with Class “Application” grows. For example, a new Sub-Class can be added under the Class “Application” 404 in the base ontology 412. By reading the merging policy 324, the merger 322 can deduce that the new Sub-Class should be added to the composite ontology 440, and can add the new Sub-Class to the composite ontology 440 without any user action. Thus, the merging policies 324 allow the compiler 320 to automatically correct the parts of the composite ontology 440 as the base ontologies, e.g., base ontology 412, evolve over time.

When two base ontologies having entities with the same name are merged those entities will appear twice in the resultant composite ontology. This is because the Internationalized Resource Identifier (IRI) of the entities are different in the base ontologies. Hence these will be treated as separate entities and will result in duplicates. To reduce the memory and processing power required to store and use the composite ontology, the composite ontology should not include duplicated definitions of Data Properties, Object Properties and Cardinality Restrictions. Referring to FIG. 3, the merger 322 thus includes a deduplication engine 326 that automatically removes the resulting duplicates from the composite ontology 340.

To remove the duplicates, the deduplication engine 326 assumes that entities with the same names in the base ontologies are conceptually the same and entities which are conceptually the same should have similar names. Entities that have same or similar names in the base ontologies 312 are merged into a single entity in the composite ontology 340. Multiple Classes can be united into a single Class. Merging also creates a union of Data Properties, Object Properties and Cardinality Restrictions, while eliminating duplicates of Properties. Entities that have different names in base ontologies 312 remain as separate entities in the composite ontology 340.

In summary, the merger 322 takes multiple base ontologies 312 as input and automatically composes them into one composite ontology 340 while eliminating duplicating entities. If there are non-overlapping Cardinality Restrictions for similar entities, such as restrictions that do not have a common range, the merger process will abort. In some examples, when there are non-overlapping Cardinality Restrictions, the ontology compiler 320 generates a notification for a user, notifying the user of the identifies conflicting Cardinality Restrictions. The ontology compiler 320 can then receive user input specifying how the conflicts should be resolved, and the ontology compiler 320 continues the merging process.

Base ontologies 312 can evolve over time, making the composite ontology 340 out-of-sync with the base ontologies as the underlying base ontologies change. To maintain the composite ontology 340 up to date, the synchronizer 330 applies update rules 328 to the composite ontology 340. When a base ontology changes, the synchronizer 330 updates the composite ontology or ontologies that were created using the base ontology, according to the update rules 328. The synchronizer 330 includes an update engine 332 that makes changes to the composite ontology 340 in order to synchronize the composite ontology 340 with the merged base ontologies 312.

The synchronizer 330 keeps the composite ontology 340 updated when any of the base ontologies 312 change. For example, when the modeler 302a of the base ontology 312a removes a particular Class from the base ontology 312, the synchronizer 330 updates the composite ontology or ontologies created from the base ontology 312a to remove the particular Class. The ontology update procedure can be performed as part of the CI/CD process.

The latest version of a base ontology can be referred to as the new base ontology, and can be represented by “V1.” The version prior to the latest version can be referred to as an old base ontology, and can be represented by “V0.” The latest version of a composite ontology can be referred to as a composite ontology, and can be represented by “V0.1.” When updates are made to a composite ontology, sequential new versions of the composite ontology can be represented by “V0.2,” “V0.3,” “V0.4,” and so on.

To update the composite ontology, the synchronizer 330 compares an old base ontology V0, a new base ontology V1, and a composite ontology V0.1. The update engine 332 makes changes per entity based on differences detected between V0, V1, and V0.1, using the update rules 328. An entity could be any statement, (e.g., a Class definition, a Property definition, a Property Type Restriction, a Property Cardinality Restriction). Different update rules 328 may apply to different types of changes.

Table 1 lists various ontology update rules 328 and scenarios that capture changes at the entity level using the corresponding update rule 328. The columns of Table 1 represent: update rule, difference scenario, the inclusion of the entity in the old base ontology V0, the new base ontology V1, and the composite ontology V0.1. a textual description of the scenario, and the expected outcome. The inclusion or exclusion of an entity in the respective ontologies is represented by either a 1 or a 0. A value of 1 represents that an entity is added or present, a value of 0 represents that an entity is deleted or not present. Entities can be, for example, a Class, Sub-Class, Data Property, Object Property, or Cardinality Restriction. The expected outcome for a given scenario indicates whether the entity is to be includes in the next version of the composite ontology, e.g., V0.2.

TABLE 1

| | | | | | | Expected |
|---|---|---|---|---|---|---|
| Update | | | | | | Outcome |
| Rule | Scenario | V0 | V0.1 | V1 | Scenario Description | (V0.2) |
| 1 | No change in base | 1 | 1 | 1 | All agree | Included |
| | and composite | | | | | |
| | ontologies | | | | | |
| 2 | Base ontology | 1 | 1 | 0 | Base ontology modeler | Not |
| | ignored statement | | | | removes an existing entity in | Included |
| | | | | | new version of Base ontology | |
| 3 | Composite | 1 | 0 | 1 | Composite ontology modeler | Not |
| | ontology ignored | | | | removes an existing entity | Included |
| | statement | | | | from composite ontology | |
| 4 | Base and | 1 | 0 | 0 | Change in Composite and Base | Not |
| | composite | | | | Ontology: Removes an existing | Included |
| | ontology ignored | | | | entity | |
| | statement | | | | | |
| 5 | Base and | 0 | 1 | 1 | Change in Composite and Base | Included |
| | composite | | | | Ontology: Add a new entity | |
| | ontology agreed | | | | | |
| | on a new entity | | | | | |
| 6 | Composite | 0 | 1 | 0 | Change in composite ontology: | Included |
| | ontology addition | | | | Composite ontology modeler | |
| | | | | | adds a new entity | |
| 7 | Base ontology | 0 | 0 | 1 | Change in Base Ontology: Base | Included |
| | addition | | | | ontology modeler adds a new | |
| | | | | | entity in new version of Base | |
| | | | | | ontology | |

The first row of Table 1 corresponds to an entity that appears in the old and new base ontology and in the composite ontology. The entity is kept in the composite ontology. Rule 1 in Table 1 applies in this case, when there is no change in base and composite ontologies. Since the modelers of base and composite ontology determined that a statement is needed to define the concept, the statement is included in the new version V0.2 of composite ontology.

The second row of Table 1 corresponds to an entity that is removed from the base ontology. In such case, the entity should be removed from the composite ontology. Rule 2 in Table 1 applies in this case, when the entity is ignored in the base ontology. Since the modeler of base ontology determined that a statement is no longer needed to define the concept, this statement is removed from the new version V0.2 of composite ontology.

The third row of Table 1 corresponds to an entity that is removed from the composite ontology and did not change in the base ontology. In such a scenario, the entity is not included, since the modeler of the composite ontology already determined not to include the entity. Rule 3 in Table 1 applies in this case, when the entity is ignored in the composite ontology. This statement is therefore removed from the new version V0.2 of composite ontology.

The fourth row of Table 1 corresponds to an entity that is removed from the base ontology and the composite ontology. Rule 4 in Table 1 applies in this case, when the entity is ignored in both the base ontology and the composite ontology. The modeler of the base ontology and the modeler of the composite ontology both determined that the statement is not needed. This statement is therefore removed from the new version V0.2 of composite ontology.

The fifth row of Table 1 corresponds to an entity that is added to the new base ontology and in the composite ontology. Rule 5 in Table 1 applies in this case, when the entity is included in both the new base ontology and the composite ontology. The modeler of the base ontology and the modeler of the composite ontology both determined that the statement is needed. This statement is therefore included in the new version V0.2 of composite ontology.

The sixth row of Table 1 corresponds to an entity that is added to the composite ontology. Rule 6 in Table 1 applies in this case, when there is an addition to the composite ontology. The modeler of composite ontology determined to add a new statement. This statement is therefore included in the new version V0.2 of composite ontology.

The seventh row of Table 1 corresponds to an entity that is added to the new base ontology. Rule 7 in Table 1 applies in this case, when there is an addition to the base ontology. The modeler of base ontology determined to add a new statement. This statement is therefore included in the new version V0.2 of composite ontology. In some examples, the compiler 320 determines whether the new statement added to the base ontology satisfies the criteria specified by the merging policies b 324 l for inclusion in the composite ontology 340. When the new statement satisfies the criteria, the update engine 332 updates the composite ontology 340 to add the new statement. When the new statement does not satisfy the criteria, the update engine 332 does not update the composite ontology 340 to add the new statement.

In summary, the composite ontology is updated by comparing the new base ontology, the old base ontology (e.g., the base ontology merged when composing the composite ontology), and the latest version composite ontology, and creating a new version of the composite ontology.

To automatically manage the changes in the ontologies, the compiler 320 can be integrated into a CI/CD pipeline. To follow a CI/CD process, the base ontologies and the composite ontologies can be stored in a respective dedicated location. For example, the base ontologies can be stored in a “base” folder, and composite ontologies can be stored in a “composite” folder. Every time a composite ontology is updated, a new version of the composite ontology is created.

When the modeler of a base ontology pushes a change, all composite ontologies that use the base ontology are automatically updated and validated according to the update rules 328, such as Rules 1 to 7 shown in Table 1. If the change is expected to cause conflicts in one or more composite ontologies, the compiler 320 can provide a notification to the modeler of the base ontology. If the modeler still pushes the changes, the compiler 320 can provide a notification to the modelers of the composite ontologies (e.g., the modeler 302d of the composite ontology 340).

In some examples, the system includes multiple composite ontologies. Each composite ontology includes a combination of two or more base ontologies. Each base ontology 312 can be merged, in total or in part, into one or more composite ontologies. When the compiler 320 detects a change to a base ontology, e.g., base ontology 312a, the compiler 320 identifies the composite ontologies into which the base ontology 312 a has been merged. The compiler 320 updates any composite ontologies into which the base ontology 312a has been merged to reflect the detected change to the base ontology 312.

Using ontologies has many advantages in enabling the ability to share and re-use domain knowledge between stakeholders. If a large ontology is needed, multiple existing base ontologies can be merged to generate a composite ontology. When a composite ontology is created, it can then be re-used. By combining available ontologies, the pool of terms or resources can be widened. Merging ontologies is therefore beneficial in providing a rich base of knowledge of a particular domain in order to streamline new projects.

The ontology compiler 320 can be used within a CI/CD pipeline of ontology-driven information systems. In some examples, the compiler 320 can automatically update the composite ontologies as and when any of the base ontologies used to create the composite ontologies change. This process can be used to manage data models that govern different data products.

In some examples, as new ontologies are introduced, the compiler 320 can incorporate the new ontologies into composite ontologies. For example, the merging policies 324 can include merging policies that apply to a catalog of ontologies. The catalog of ontologies can include multiple ontologies that include a common class. The merging policies 324 can be associated with the common Class. When a new base ontology is introduced to the catalog of ontologies (e.g., for specific data products), the compiler can determine that the new base ontology includes the common Class, and automatically add the new base ontology to existing composite ontologies using the merging policies 324 that are applicable to the catalog. The compiler 320 can ensure the consistency of graph database systems that use ontologies as a formal data model, such as Neo4j, StarDog or in Distributed Data Catalogs such as Anzo.

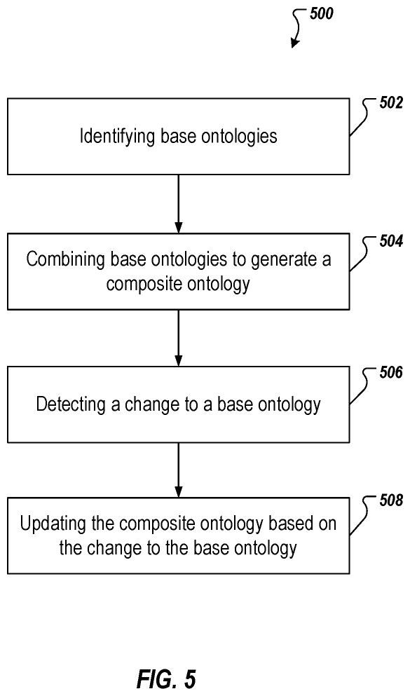

FIG. 5 is a flowchart of an example process 500 that can be executed in accordance with implementations of the present disclosure. In some implementations, the example process 500 may be performed using one or more computer-executable programs executed using one or more computing devices.

The process 500 includes identifying base ontologies (502). The base ontologies can include multiple base ontologies, each ontology provided as a computer-readable data structure. A base ontology includes entities such as Classes, Sub-Classes, Data Properties, Object Properties, and Cardinality Restrictions.

The process 500 includes combining base ontologies to generate a composite ontology (504). Multiple base ontologies can be combined to generate a composite ontology, in part, by automatically comparing entity names of classes of a first base ontology to classes of a second base ontology. The multiple base ontologies are combined to generate a composite ontology, in part, by automatically determining that an entity name of a first class of the first base ontology matches an entity name of a second class of the second base ontology. In response, a class is provided within the composite ontology that represents the first class and the second class. The class is provided within the composite ontology at least partially by determining a union of Data Properties, Object Properties, and Cardinality Restrictions of the first class and the second class for the class. After combining the multiple base ontologies to generate the composite ontology, the compiler identifies duplicate entities and removes the identified duplicate entities from the composite ontology.

The process 500 includes detecting a change to a base ontology (506). In some examples, the compiler detects a change input by a user to one of the base ontologies. A change to a base ontology can be, for example an addition or removal of an entity. A change to a base ontology can be a modification of a property of an entity, a modification of data properties, a modification of object properties, or any combination of these.

The process 500 includes updating the composite ontology based on the change to the base ontology (508). The compiler can update the composite ontology by applying update rules to the composite ontology. In some examples, the update rules are received as user input. The update rules can be defined by a user, and used by the compiler to automatically update the composite ontology as the modular ontologies change. In some examples, the update rules specify removing, from the composite ontology, an entity that was removed from a base ontology of the multiple base ontologies. In some examples, the update rules specify adding, to the composite ontology, an entity that was added to a base ontology of the multiple base ontologies.

The update process can repeat by the system 300 comparing the base ontologies to the composite ontology intermittently, periodically, and/or on demand. In some examples, the system 300 perform the update process at designated intervals, e.g., once per hour, once per day. In some examples, the system 300 performs the update process when base ontologies change. For example, the system 300 can monitor for changes in the base ontologies. In some examples, the system 300 receives data indicating that a change occurred in at least one of the base ontologies, and in response, performs the update process. In some examples, the system 300 receives a user request to perform an update to a composite ontology, and in response, performs the update process. Thus, the composite ontology 312 is maintained current and up to date with the latest version of base ontologies.

The composite ontology can be validated and updated as part of a CI/CD process. The compiler uses an automatic and systematic approach to selectively merge entities from base ontologies. The composite ontology is then updated whenever a base ontology changes based on the update rules and the merging policies.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, e.g., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code) that constitutes processor firmware, a protocol stack, a database management system, an operating system, or a combination of one or more of them. A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display), LED (light-emitting diode) monitor, for displaying information to the user and a keyboard and a pointing device (e.g., a mouse or a trackball), by which the user may provide input to the computer. Other kinds of devices may be used to provide for interaction with a user as well; for example, feedback provided to the user may be any appropriate form of sensory feedback (e.g., visual feedback, auditory feedback, or tactile feedback); and input from the user may be received in any appropriate form, including acoustic, speech, or tactile input.

Implementations may be realized in a computing system that includes a back end component (e.g., as a data server), or that includes a middleware component (e.g., an application server), or that includes a front end component (e.g., a client computer having a graphical user interface or a Web browser through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”) (e.g., the Internet).

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims. The appendix included with this disclosure provides additional, alternative, and/or further elaborative examples of the systems and methods described herein and is part of this specification.

1. A computer-implemented method for providing a composite ontology from a plurality of base ontologies, each ontology being provided as a computer-readable data structure, the method comprising:
identifying the plurality of base ontologies;
combining the plurality of base ontologies to generate the composite ontology by, automatically:
comparing entity names of classes of a first base ontology to classes of a second base ontology, and
determining that an entity name of a first class of the first base ontology matches an entity name of a second class of the second base ontology, and in response, providing a class within the composite ontology that represents the first class and the second class at least partially by determining a union of data properties, object properties, and cardinality restrictions of the first class and the second class for the class;
after combining the plurality of base ontologies to generate the composite ontology, detecting a change to at least one of the plurality of base ontologies; and p1 updating the composite ontology based on the detected change to the at least one of the plurality of base ontologies.

2. The method of claim 1, wherein a base ontology of the plurality of base ontologies includes one or more entities including at least one of classes, sub-classes, data properties, object properties, and cardinality restrictions.

3. The method of claim 2, comprising:
after combining the plurality of base ontologies to generate the composite ontology, identifying duplicate entities; and
removing the identified duplicate entities from the composite ontology.

4. The method of claim 1, wherein combining the plurality of base ontologies to generate the composite ontology comprises:
combining a first portion of the first base ontology with a second portion of the second base ontology, the first portion and the second portion being selected based on a set of merging policies.

5. The method of claim 4, wherein the set of merging policies specifies, for an entity of the first base ontology or the second base ontology, whether the entity is to be included in the composite ontology.

6. The method of claim 4, wherein the set of merging policies specifies, for a first entity of the first base ontology or the second base ontology, whether a second entity is to be included in the composite ontology, the second entity being linked to the first entity.

7. The method of claim 6, wherein the second entity is linked to the first entity by one or more of:
the second entity is a parent or child of the first entity;
the second entity is a property of the first entity;
the second entity is an inherited property of the first entity; and
the second entity is a referenced class of the first entity.

8. The method of claim 4, wherein the set of merging policies specifies properties of entities that are to be included in the composite ontology.

9. The method of claim 4, comprising receiving, as user input, policy data defining the set of merging policies.

10. (canceled)

11. The method of claim 1, wherein updating the composite ontology based on the detected change to the at least one of the plurality of base ontologies comprises applying one or more update rules to the composite ontology.

12. The method of claim 11, wherein the one or more update rules are received as user input.

13. The method of claim 1, wherein updating the composite ontology based on the detected change to the at least one of the plurality of base ontologies comprises:
removing, from the composite ontology, an entity that was removed from a base ontology of the plurality of base ontologies after combining the plurality of base ontologies to generate the composite ontology.

14. The method of claim 1, wherein updating the composite ontology based on the detected change to the at least one of the plurality of base ontologies comprises:
adding, to the composite ontology, an entity that was added to a base ontology of the plurality of base ontologies after combining the plurality of base ontologies to generate the composite ontology.

15. The method of claim 1, wherein detecting the change to the at least one of the plurality of base ontologies comprises detecting a change input by a user to the at least one of the plurality of base ontologies after combining the plurality of base ontologies to generate the composite ontology.

16. The method of claim 1, wherein a base ontology of the plurality of base ontologies represents databases of tables.

17. The method of claim 1, comprising presenting a visual representation of the composite ontology on a user interface.

18. A non-transitory computer-readable storage medium coupled to one or more processors and having instructions stored thereon which, when executed by the one or more processors, cause the one or more processors to perform operations for providing a composite ontology from a plurality of base ontologies, each ontology being provided as a computer-readable data structure, the operations comprising:
identifying the plurality of base ontologies;
combining the plurality of base ontologies to generate the composite ontology by, automatically:
comparing entity names of classes of a first base ontology to classes of a second base ontology, and
determining that an entity name of a first class of the first base ontology matches an entity name of a second class of the second base ontology, and in response, providing a class within the composite ontology that represents the first class and the second class at least partially by determining a union of data properties, object properties, and cardinality restrictions of the first class and the second class for the class;
after combining the plurality of base ontologies to generate the composite ontology, detecting a change to at least one of the plurality of base ontologies; and
updating the composite ontology based on the detected change to the at least one of the plurality of base ontologies.

19. The non-transitory computer-readable storage medium of claim 18, wherein a base ontology of the plurality of base ontologies includes one or more entities including at least one of classes, sub-classes, data properties, object properties, and cardinality restrictions.

20. A system, comprising:
a computing device; and
a computer-readable storage device coupled to the computing device and having instructions stored thereon which, when executed by the computing device, cause the computing device to perform operations for providing a composite ontology from a plurality of base ontologies, each ontology being provided as a computer-readable data structure, the operations comprising:
identifying the plurality of base ontologies;
combining the plurality of base ontologies to generate the composite ontology by, automatically:
comparing entity names of classes of a first base ontology to classes of a second base ontology, and
determining that an entity name of a first class of the first base ontology matches an entity name of a second class of the second base ontology, and in response, providing a class within the composite ontology that represents the first class and the second class at least partially by determining a union of data properties, object properties, and cardinality restrictions of the first class and the second class for the class;
after combining the plurality of base ontologies to generate the composite ontology, detecting a change to at least one of the plurality of base ontologies; and
updating the composite ontology based on the detected change to the at least one of the plurality of base ontologies.
